(19) United States
(12) Patent Application Publication
(10) Pub. No.: US 2021/0017614 A1
(43) Pub. Date: Jan. 21, 2021

(54) LEATHER MATERIAL, COMPOSITION FOR FORMING TOP COAT OF LEATHER MATERIAL, AND METHOD FOR PRODUCING LEATHER MATERIAL

(71) Applicants: NISSAN MOTOR CO., LTD., Yokohama-shi, (JP); GST Acquisition Corp., Rochester Hills, MI (US)

(72) Inventors: Motohiko KURODA, Kanagawa (JP); Yuji YAMASAKI, Kanagawa (JP); Hiroki IMADA, Kanagawa (JP); Narimitsu HAYASHI, Rochester Hills, MI (US); Jeffrey D. Miller, Rochester Hills, MI (US)

(73) Assignees: NISSAN MOTOR CO., LTD., Yokohama-shi, (JP); GST Acquisition Corp., Rochester Hills, MI (US)

(21) Appl. No.: 16/512,584

(22) Filed: Jul. 16, 2019

(51) Int. Cl. C14C 11/00; C08L 75/06; C08L 75/08

(52) U.S. Cl. CPC C14C 11/006; C08L 75/08; C08L 75/06

(57) ABSTRACT

Provided is a leather material comprising a top coat having at least one layer on a leather substrate, wherein at least one of the layer contains a polycarbonate polyurethane resin, a polyester polyurethane resin, and a polyether polyurethane resin.

### FIELD OF INVENTION

The present invention relates to a leather material, a composition for forming a top coat of a leather material, and a method for producing a leather material.

### RELATED ARTS

Leather materials like wallet and leather shoes are generally produced by subjecting animal leather or the like to surface treatment called tanning process, followed by dyeing. Meanwhile, compared to those leather products, leather materials used for a dashboard or a sheet of an automobile (leather materials for automobile) need to make a user feel gloss and texture peculiar to leather while simultaneously being suitable for use under more severe conditions (temperature, humidity, and sunshine). Due to this reason, the leather materials for automobile are required to have mechanical strength such as flex resistance or abrasion resistance, light resistance, or the like while maintaining the specific gloss of leather. Among those characteristics, for the purpose of attaining mechanical strength and light resistance, several layers of a coating film (for example, base coat, color coat, and top coat) are formed on a surface in addition to the aforementioned tanning process (surface treatment) and dyeing. Meanwhile, for the purpose of attaining gloss, a surface of a leather material is generally polished to gloss (see, JP 2010-235770 A, for example).

### SUMMARY OF INVENTION

However, because the glossing as described above is manual work, there is a problem that mass production is difficult or much expensive particularly for large-area leather materials such as automobile leather materials.

Accordingly, the present invention is devised in consideration of the above circumstances. It is an object of the present invention to provide a high-gloss leather material excellent in mass productivity.

The present inventors have conducted intensive studies to solve the above problems, to find that the problems can be solved by forming a top coat containing specific resins in combination on a leather substrate, and completed the present invention accordingly.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a cross-section illustrating one embodiment of the leather material of the present invention. In FIG. 1, 1 represents a leather material; 2 represents a leather substrate; 3 represents abase coat; 4 represents a color coat; and each of 5a and 5b represents a top coat layer;

FIG. 2 is a drawing illustrating the shape of a test sample used for the measurement of tensile strength (Tensile); and

FIGS. 3A and 3B are drawings for explaining the evaluation of flex resistance (Newark Flex).

### DETAILED DESCRIPTION OF THE INVENTION

According to a first aspect, the present invention relates to a leather material comprising a top coat having at least one layer on a leather substrate, wherein at least one of the layer contains a polycarbonate polyurethane resin, a polyester polyurethane resin, and a polyether polyurethane resin.

According to a second aspect, the present invention relates to a composition for forming a top coat of leather material, the composition comprising a polycarbonate polyurethane resin, a polyester polyurethane resin, and a polyether polyurethane resin.

According to a third aspect, the present invention relates to a method for forming a leather material comprising forming a top coat on a leather substrate by using the composition of the present invention.

The leather material having the above constitution has high gloss. Furthermore, according to the above constitution, a top coat layer can be formed by dissolving the three types of resins in a suitable solvent, if necessary, to prepare a coating agent, and applying the coating agent. Accordingly, mass productivity usable for industrial products such as automobiles can be achieved. As such, according to the present invention, a high-gloss leather material with excellent mass productivity can be provided. In addition, the leather material having the above constitution has excellent mechanical strength such as flex resistance or abrasion resistance while it maintains specific gloss of leather. With regard to the above characteristics, the polycarbonate polyurethane resin mainly serves to impart gloss to a leather material. The polyester polyurethane resin mainly serves to impart flex resistance to a leather material. The polyether polyurethane resin mainly serves to impart the abrasion resistance to a leather material. Thus, the leather material having the top coat (top coat layer) containing the three kinds of resins can exhibit the characteristics (especially high gloss, flex resistance, abrasion resistance) required for the leather material (in particular, genuine leather material) in a well-balanced manner. It is to be noted that the above is an assumption, and the present invention is not limited thereto.

Hereinafter, one or more embodiments of the present invention will be described with reference to the drawings. However, the scope of the invention is not limited to the disclosed embodiments. In the description of the drawings, the same element is denoted by the same reference numeral, and redundant description is omitted. In addition, in some cases, dimensional ratios in the drawings are exaggerated and different from actual ratios for convenience of the description. Furthermore, in the present description, “X to Y” indicates a range and means “X or more and Y or less”. In addition, unless otherwise specified, operation and measurements of physical properties, and the like, are performed at room temperature (20 to 25° C.)/relative humidity of 40 to 50% RH.

### [Leather Material]

The leather material of the present invention has a top coat having at least one layer (top coat layer) on a leather substrate. Herein, the top coat may be directly disposed on a surface of a leather substrate, or it may be disposed on a leather substrate via another layer. Preferably, the top coat is formed on a leather substrate via a base coat and a color coat. Namely, in a preferred embodiment of the present invention, the leather material further includes a base coat and a color coat between the leather substrate and the top coat. According to this embodiment, the disposition (order of formation) of leather substrate, base coat, color coat, and top coat is not particularly limited, but it is preferable to dispose (form) a leather substrate, a base coat, a color coat, and a top coat in this order. As used herein, the expression “top coat is disposed (formed) on a leather substrate” includes both case in which the top coat is directly disposed (formed) on a leather substrate and case in which the top coat is disposed (formed) on a leather substrate via another layer (e.g., a base coat, and a color coat).

The leather material of the present invention may also comprise a top coat having two or more layers (top coat layers) on a leather substrate (i.e., the top coat may be one layer (one top coat layer) or be composed of two or more layers (top coat layers)). By making the top coat two or more layers, it is possible to divide the properties required by the final product (leather material) for each layer, or to complement desired characteristics in each layer. For example, in the case of providing a two-layer top coat on a leather substrate, a composition of the each layer is adjusted so as that the outermost top coat layer exhibits high gloss, flex resistance and abrasion resistance, and the other top coat layer (top coat layer on the leather substrate side) exhibits tensile strength , elongation and flex resistance. By this, the leather material as a final product can exert high gloss, abrasion resistance, tensile strength, and elongation and simultaneously can show enhanced flex resistance as compared to a leather material having only one layer disposed. Herein, total number of layers of the top coat (e.g. , total number of top coat layers) is, although not particularly limited, preferably 1 to 3 layers, and more preferably 2 to 3 layers. With this number of layer, sufficient production efficiency can be achieved even in the case of mass production (and thus the cost can be saved), and desired characteristics can be sufficiently satisfied. Furthermore, when two or more layers of top coat are formed on a leather substrate, any layer can contain a polycarbonate polyurethane resin, a polyester polyurethane resin, and a polyether polyurethane resin. Because the gloss and abrasion resistance are preferably exhibited on the outermost side of a leather material, it is preferable that at least the outermost top (the outermost top coat layer) contains a polycarbonate polyurethane resin, a polyester polyurethane resin, and a polyether polyurethane resin. Namely, in the preferred embodiment of the present invention, 1 to 3 layers of top coat are disposed on a leather substrate and at least the outermost layer of the top coat (the outermost top coat layer) contains a polycarbonate polyurethane resin, a polyester polyurethane resin, and a polyether polyurethane resin. According to the more preferred embodiment of the present invention, a base coat, a color coat, and 2 to 3 layers of top coat (2 to 3 topcoat layers) are disposed on a leather substrate in this order, and the outermost layer of the top coat (the outermost top coat layer) contains a polycarbonate polyurethane resin, a polyester polyurethane resin, and a polyether polyurethane resin. As used herein, the expression “the outermost” means a side that is directly exposed to the eyes of a user and indicates the farthest side from a leather substrate.

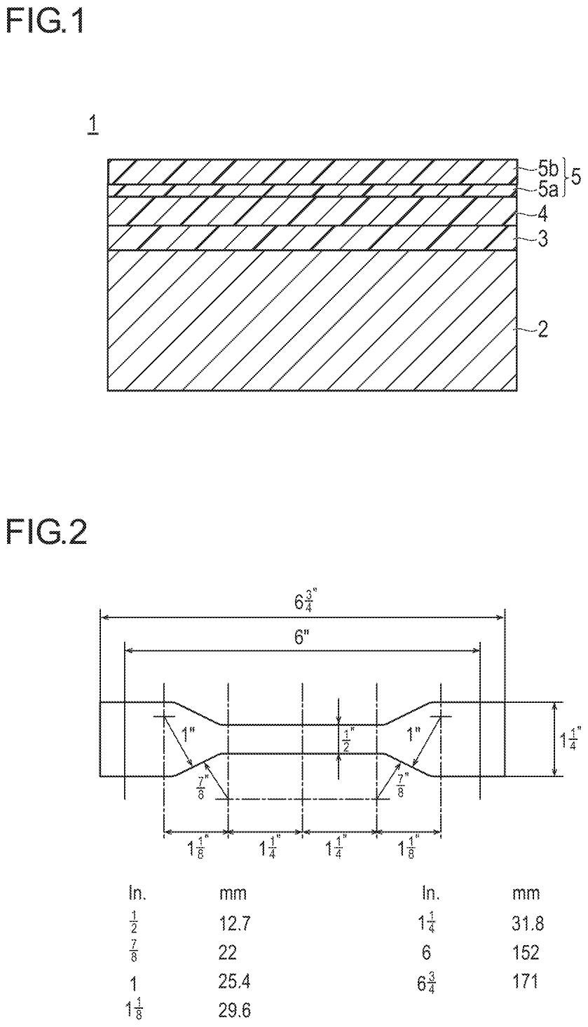

Hereinafter, specific explanation is given for an embodiment in which the leather material is constituted with a leather substrate, a base coat, a color coat, and 2 layers of top coat. However, the present invention is not limited to the following embodiment. FIG. 1 is a cross-sectional drawing illustrating one embodiment of the leather material of the present invention. In FIG. 1, a leather material 1 is formed by having, on a leather substrate 2, a base coat 3, a color coat 4, and a top coat 5 composed of a top coat layer 5a and a top coat layer 5b disposed in this order.

### (Top Coat)

The top coat is formed on the outermost side of a leather substrate and the outermost side of top coat (the outermost top coat layer) is directly exposed to the eyes of a user. Accordingly, the top coat (in particular, the outermost top coat layer) is required to have high gloss. Furthermore, in the use for a dashboard and a sheet of an automobile or the like, the outermost top coat layer is frequently touched by a user (e.g., human) and/or its shape is often changed. Accordingly, the topcoat (in particular, the outermost top coat layer) is required to have, in addition to high gloss, excellent abrasion resistance and/or flex resistance. In addition, depending on use (e.g., dashboard or sheet of an automobile), the top coat (in particular, the outermost topcoat layer) is required to have suitable smooth feeling, flexibility, or the like. As described above, when the top coat have 2 or more layers, the above desired characteristics can be divided or complemented in each top coat layer, which is preferable.

At least one layer of the top coat contains a polycarbonate polyurethane resin, a polyester polyurethane resin, and a polyether polyurethane resin. Herein, a composition of each resin in the top coat layer is not particularly limited. A content of the polycarbonate polyurethane resin in the top coat layer is preferably 5 to 40% by weight, more preferably more than 5% by weight but less than 35% by weight, even more preferably 10 to 25% by weight, and particularly preferably 15% by weight or more but less than 25% by weight, relative to the total weight of the polycarbonate polyurethane resin, the polyester polyurethane resin, and the polyether polyurethane resin. A content of the polyester polyurethane resin in the top coat layer is preferably 15% by weight or more but less than 50% by weight, more preferably 25 to 45% by weight, even more preferably 30 to 45% by weight, and particularly preferably 35 to 40% by weight, relative to the total weight of the polycarbonate polyurethane resin, the polyester polyurethane resin, and the polyether polyurethane resin. A content of the polyether polyurethane resin in the top coat layer is preferably 15% by weight or more but less than 50% by weight, more preferably 25 to 45% by weight, even more preferably 30 to 45% by weight, and particularly preferably 35 to 40% by weight, relative to the total weight of the polycarbonate polyurethane resin, the polyester polyurethane resin, and the polyether polyurethane resin. With such a composition, a top coat (and thus, leather material) having a more favorable balance of high gloss, flex resistance (crack resistance), and abrasion resistance can be obtained. As used herein, the content means a content of each resin in the top coat layer containing the above three types of resins. Namely, in the preferred embodiment of the present invention, the polycarbonate polyurethane resin is contained in the top coat layer at a ratio of 5 to 40% by weight relative to the total weight of the polycarbonate polyurethane resin, the polyester polyurethane resin, and the polyether polyurethane resin; the polyester polyurethane resin is contained in the top coat layer at a ratio of 15% by weight or more but less than 50% by weight relative to the total weight of the polycarbonate polyurethane resin, the polyester polyurethane resin, and the polyether polyurethane resin; and the polyether polyurethane resin is contained in the top coat layer at a ratio of 15% by weight or more but less than 50% by weight relative to the total weight of the polycarbonate polyurethane resin, the polyester polyurethane resin, and the polyether polyurethane resin. According to the more preferred embodiment of the present invention, the polycarbonate polyurethane resin is contained in the top coat layer at a ratio of more than 5% by weight but less than 35% by weight relative to the total weight of the polycarbonate polyurethane resin, the polyester polyurethane resin, and the polyether polyurethane resin; the polyester polyurethane resin is contained in the top coat layer at a ratio of 25 to 45% by weight relative to the total weight of the polycarbonate polyurethane resin, the polyester polyurethane resin, and the polyether polyurethane resin; and the polyether polyurethane resin is contained in the top coat layer at a ratio of 25 to 45% by weight relative to the total weight of the polycarbonate polyurethane resin, the polyester polyurethane resin, and the polyether polyurethane resin. According to the even more preferred embodiment of the present invention, the polycarbonate polyurethane resin is contained in the top coat layer at a ratio of 10 to 25% by weight relative to the total weight of the polycarbonate polyurethane resin, the polyester polyurethane resin, and the polyether polyurethane resin; the polyester polyurethane resin is, contained in the top coat layer at a ratio of 30 to 45% by weight relative to the total weight of the polycarbonate polyurethane resin, the polyester polyurethane resin, and the polyether polyurethane resin; and the polyether polyurethane resin is contained in the top coat layer at a ratio of 30 to 45% by weight relative to the total weight of the polycarbonate polyurethane resin, the polyester polyurethane resin, and the polyether polyurethane resin. According to the particularly preferred embodiment of the present invention, the polycarbonate polyurethane resin is contained in the top coat layer at a ratio of 15% by weight or more but less than 25% by weight relative to the total weight of the polycarbonate polyurethane resin, the polyester polyurethane resin, and the polyether polyurethane resin; the polyester polyurethane resin is contained in the top coat layer at a ratio of 35 to 40% by weight relative to the total weight of the polycarbonate polyurethane resin, the polyester polyurethane resin, and the polyether polyurethane resin; and the polyether polyurethane resin is contained in the top coat layer at a ratio of 35 to 40% by weight relative to the total weight of the polycarbonate polyurethane resin, the polyester polyurethane resin, and the polyether polyurethane resin.

Presence of each resin in the top coat layer can be determined by carrying out an NMR measurement (¹H-NMR measurement, ¹³C-NMR measurement, or the like), infrared spectrum analysis, GC-MS analysis, or the like, for example. In the present specification, the presence of a polycarbonate polyurethane resin, a polyester polyurethane resin, and a polyether polyurethane resin in the top coat layer is confirmed by an infrared spectrum analysis.

The polycarbonate polyurethane resin serves to smoothen a surface so as to impart transparency or gloss to a top coat. As such, the polycarbonate polyurethane resin mainly contributes to enhancement of gloss. Furthermore, the polycarbonate polyurethane resin may also contribute to enhancement of flex resistance and/or abrasion resistance. The polycarbonate polyurethane resin is a polyurethane resin having polycarbonate skeleton in the main chain, and is synthesized by urethane reaction between polycarbonate diol and diisocyanate. The polycarbonate polyurethane resin may be of non-crosslinked or crosslinked type. The polycarbonate diol is obtained by reacting at least one carbonate compound selected from the group consisting of alkylene carbonate, diaryl carbonate, and dialkyl carbonate with diol and/or polyether polyol. Among the carbonate compounds, examples of the alkylene carbonate include ethylene carbonate, 1,2-propylene carbonate, 1,2-butylene carbonate, and the like, although it is not limited thereto. Examples of the diaryl carbonate include diphenyl carbonate, phenyl-naphthyl carbonate, dinaphthyl carbonate, 4-methyldiphenyl carbonate, 4-ethyldiphenyl carbonate, 4-propyldiphenyl carbonate, 4,4′-dimethyl-diphenyl carbonate, 4,4′-diethyl-diphenyl carbonate, 4,4′-dipropyl-diphenyl carbonate, and the like, although it is not limited thereto. Examples of the dialkyl carbonate include dimethyl carbonate, diethyl carbonate, di-n-propyl carbonate, diisopropyl carbonate, di-n-butyl carbonate, diisobutyl carbonate, di-t-butyl carbonate, di-n-amyl carbonate, diisoamyl carbonate, and the like, although it is not limited thereto. Examples of the diol to be reacted with the carbonate compound include ethylene glycol, 1,2-propane diol, 1,3-propane diol, 1,3-butane diol, 1,4-butane diol, 2-methyl-1,3-propane diol, neopentyl glycol, 2-methyl-pentane diol, 3-methyl-pentane diol, 2,2,4-trimethyl-1,6-hexane diol, 2,3,5-trimethylpentane diol, a mixture thereof, and the like, although it is not limited thereto. Furthermore, examples of the polyether polyol include polytetramethylene glycol obtained by ring-opening polymerization of tetrahydrofuran, alkylene oxide adduct of dials, a mixture thereof, and the like, although it is not limited thereto. Examples of the dials include ethylene glycol, 1, 2-propane diol, 1,3-propane diol, 1,3-butane diol, 1,4-butane diol, isomeric pentane dials, isomeric hexane dials, or octane dials (e.g., 2-ethyl-1,3-hexane diol, 1,2-bis(hydroxymethyl)-cyclohexanone, 1,3-bis(hydroxymethyl)-cyclohexanone, 1,4-bis(hydroxymethyl)-cyclohexanone, and trimethylol propane), glycerin, and the like, although it is not limited thereto. Furthermore, examples the alkylene oxide include ethylene oxide, propylene oxide, 1,2-butylene oxide, 1,3-butylene oxide, 2,3-butylene oxide, tetrahydrofuran, styrene oxide, epichlorohydrin, and the like, although it is not limited thereto. The alkylene oxide maybe used either singly or in combination of two or more types thereof. The dials and polyether polyols may be also used either singly or in combination of two or more types thereof. Weight average molecular weight of the polycarbonate dial is, although not particularly limited, preferably 500 to 4,000, and more preferably 1,000 to 3,000 from the viewpoint of the effect of further enhancing the surface smoothness (and thus gloss and/or transparency) and the like. Furthermore, examples of the diisocyanate include aliphatic diisocyanate such as tetramethylene diisocyanate and hexamethylene diisocyanate (HDI), alicyclic diisocyanate such as 1,4-cyclohexanediisocyanate and isophorone diisocyanate (IPDI), aromatic diisocyanate such as tolylene diisocyanate (TDI), xylylene diisocyanate, and 4,4′-diphenylmethanediisocyanate (MDI), and the like, although it is not limited thereto. The reaction may be also carried out in the presence of a chain extending agent like 1,4-butane diol, 1,6-hexane diol, and ethylene diamine. Furthermore, the molecular weight (weight average molecular weight) of the polycarbonate polyurethane resin is, although not particularly limited, preferably 15,000 to 150,000 from the viewpoint of further enhancing the surface smoothness (and thus gloss and/or transparency), and the like. The polycarbonate polyurethane resin may be used either singly or in the form of a mixture of two or more types thereof.

In the present description, the molecular weight (weight average molecular weight) of each resin is a value measured by gel permeation chromatography (GPC) in which polystyrene is used as a reference material.

The polyester polyurethane resin serves to enhance mechanical characteristics (in particular, strength) so as to impart flex resistance to a top coat. As such, the polyester polyurethane resin mainly contributes to enhancement of flex resistance. Furthermore, the polyester polyurethane resin may also contribute to enhancement of abrasion resistance. The polyester polyurethane resin is a polyurethane resin having polyester skeleton in the main chain, and is synthesized by reaction between polyester polyol and diisocyanate. The reaction may be also carried out in the presence of a chain extending agent. Herein, examples of the polyester polyol include those obtained by polycondensation between dicarboxylic acid such as adipic acid, azelaic acid, sebacic acid, succinic acid, glutaric acid, maleic acid, furmaric acid, phthalic acid, isophthalic acid, and terephthalic acid, and glycol such as ethylene glycol, propylene glycol, 1,4-butane diol, 1,3-butane diol, 1,6-hexane diol, 1,8-octamethylene diol, neopentyl glycol, bishydroxymethylcyclohexane, bishydroxyethylbenzene, and alkyldialkanolamine, although it is not limited thereto. Furthermore, examples of the diisocyanate include 1,5-naphthylene diisocyanate, 4,4′-diphenylmethanediisocyanate, 4,4′-diphenyldimethylmethanediisocyanate, 4,4′-dibenzylisocyanate, dialkyldiphenylmethane diisocyanate, tetraalkyldiphenylmethane diisocyanate, 1,3-phenylene diisocyanate, 1,4-phenylene diisocyanate, tolylene diisocyanate, butane-1,4-diisocyanate, hexamethylene diisocyanate, isopropylene diisocyanate, methylene diisocyanate, 2,2,4-trimethylhexamethylene diisocyanate, cyclohexane-1,4-diisocyanate, xylylene diisocyanate, isophorone diisocyanate, lysine diisocyanate, dicyclohexyl methane-4,4′-diisocyanate, 1,3-bis(isocyanatemethyl)cyclohexane, methylcyclohexane diisocyanate, norbornane diisocyanate, m-tetramethylxylylene diisocyanate, a dimer diisocyanate in which the carboxy group of dimer acid is converted into an isocyanate group, and the like, although it is not limited thereto. The molecular weight (weight average molecular weight) of the polyester polyurethane resin is, although not particularly limited, preferably 15,000 to 150,000 from the viewpoint of further enhancing the mechanical characteristics (and thus flex resistance), and the like. The polyester polyurethane resin may be used either singly or in the form of a mixture of two or more types thereof. The polyether polyurethane resin serves to enhance elongation so as to impart followability upon rubbing to a top coat. As such, the polyether polyurethane resin mainly contributes to enhancement of abrasion resistance. The polyether polyurethane resin is a polyurethane resin having polyether skeleton in the main chain, and is synthesized by reaction between polyether polyol and diisocyanate. The reaction may be also carried out in the presence of a chain extending agent. Herein, the polyether polyol is not particularly limited, and the same polyether polyol as those described in the above section of polycarbonate polyurethane resin can be used. Examples of the diisocyanate include aliphatic diisocyanate and aromatic diisocyanate such as hexamethylene diisocyanate, toluidine diisocyanate, isophorone diisocyanate, 1,3-xylylene diisocyanate, 1,4-xylylene diisocyanate, cyclohexane diisocyanate, toluidine diisocyanate, 2,4-tolylene diisocyanate, 2,6-tolylene diisocyanate, 4,4′-diphenylmethanediisocyanate, p-phenylene diisocyanate, m-phenylene diisocyanate, 1,5-naphthalene diisocyanate, or the like, although it is not limited thereto. The diisocyanate may be used either singly or in combination of two or more types thereof. The molecular weight (weight average molecular weight) of the polyether polyurethane resin is, although not particularly limited, preferably 15,000 to 150,000 from the viewpoint of further enhancing the followability upon rubbing (and thus abrasion resistance), and the like. The polyether polyurethane resin may be used either singly or in the form of a mixture of two or more types thereof.

At least one layer of the top coat contains the polycarbonate polyurethane resin, the polyester polyurethane resin, and the polyether polyurethane resin as described above. It may contain another resin in addition to the above three types of resin. Preferably, the top coat layer is formed of only three types of resin, i.e., the polycarbonate polyurethane resin, the polyester polyurethane resin, and the polyether polyurethane resin.

In the case where 2 or more layers of top coat are disposed, it is only required that at least one layer of the top coat contains the polycarbonate polyurethane resin, the polyester polyurethane resin, and the polyether polyurethane resin. Herein, a resin (hereinafter, also referred to as “another resin”) to be contained in a top coat layer which does not contain the aforementioned three types in combination (hereinafter, also referred to as “another top coat layer”) is not particularly limited, and a known resin commonly used for a top coat of a leather material can be similarly used. Specific examples thereof include a polycarbonate polyurethane resin, a polyester polyurethane resin, a polyether polyurethane resin, an aliphatic polyurethane resin, a fatty acid modified polyurethane resin, an aromatic polyurethane resin, an aliphatic polyurethane acrylic resin, and the like. The another resin may be used either singly or in the form of a mixture of two or more types thereof, but the combination of a polycarbonate polyurethane resin, a polyester polyurethane resin, and a polyether polyurethane resin is excluded. Furthermore, a content (in terms of solid content) of another resin is not particularly limited, and the same amount as the amount generally contained in a top coat can be applied. Specifically, the content of another resin in another top coat layer (1 layer) is approximately 70 to 99% by weight, and preferably 80 to 95% by weight. The content of the resin means an amount contained in another top coat layer (1 layer). When another top coat layer (1 layer) contains two or more types of another resin, the content of another resin means a total amount of those resins in another top coat layer (1 layer).

The top coat (top coat layer) may contain, in addition to the aforementioned resin components, another component(s). Herein, another component(s) is not particularly limited, and the same material as the material generally used for a top coat of a leather material can be similarly used. Specific examples thereof include a pigment, a crosslinking agent (curing agent) (e.g., isocyanate-based crosslinking agent), an aid, a feeling agent (e.g., silicone-based feeling agent), a leveling agent, a thickening agent, a UV absorbing agent, and the like. The another component(s) may be used either singly or in the form of a mixture of two or more types thereof. Furthermore, it is also possible that two or more types of the above another components are used in combination. The crosslinking agent can promote crosslinking between resins during forming of a top coat to improve strength of a top coat. Also in such a case, a content of each resin can be measured by the method as described above.

A content of another component(s) is not particularly limited, and the same amount as the amount generally contained in a top coat can be applied. Specifically, a content (in terms of solid content) of each of the another component (s) is approximately 1 to 15% by weight, and preferably 3 to 10% by weight. The content of the another component(s) means a content in each top coat layer (1 layer). Furthermore, when two or more types of the another component (s) having same function are used, the content means their total amount. For example, when two or more types of pigment are contained in a top coat layer, total amount (in terms of solid content) of the pigments contained in the top coat layer (1 layer) is approximately 1 to 15% by weight, and preferably 3 to 10% by weight.

Thickness of the top coat is not particularly limited, and it can be the same as the thickness of a top coat of a common leather material. Specifically, thickness of the top coat (total thickness in dry state) is preferably 10 to 40 dim, and more preferably 20 to 30 As used herein, the “thickness of a top coat (total thickness in dry state)” means a thickness of 1 layer (in dry state) when the top coat is 1 layer, or a total thickness of each layer (in dry state) when the top coat is 2 or more layers. With the aforementioned thickness, characteristics that are required for a desired use (gloss, flex resistance (crack resistance), abrasion resistance, tensile strength, elongation, light resistance, or the like, in particular, gloss and flex resistance) can be achieved sufficiently.

From the viewpoint of further enhanced gloss, the outermost top coat layer preferably has a smooth surface, and it is more preferable that the outermost top coat layer has surface roughness (Ra) of 3 or less. Namely, in the preferred embodiment of the present invention, surface roughness (Ra) of the outermost top coat is 3 or less. A top coat having such smoothness can exhibit even higher gloss. Since the lower limit of the surface roughness (Ra) of the outermost top coat is preferably as low as possible, it is 0. However, it is only required that the lower limit is 0.3 or more. As used herein, the surface roughness (Ra) indicates a value that is measured by the method stated in the following Examples.

A method for forming a top coat is not particularly limited. A composition for forming a top coat of a leather material containing the aforementioned resins (i.e., top coating agent) can be coated on a leather substrate, a base coat, or a color coat (preferably color coat) to form a top coat. This method is simple and excellent in mass productivity. Accordingly, the present invention is also provide a composition for forming a topcoat of leather material, which includes a polycarbonate polyurethane resin, a polyester polyurethane resin, and a polyether polyurethane resin. Furthermore, the present invention is provide a method for forming a leather material comprising forming a top coat on a leather substrate by using the composition as above.

With regard to the composition for forming a top coat of a leather material according to the present invention, specific explanations of the polycarbonate polyurethane resin, the polyester polyurethane resin, and the polyether polyurethane resin, and another resin that is contained, if necessary, are the same as those described above, and thus the explanations are omitted herein. A content of each resin corresponds to the content of each resin in a top coat layer (i.e., it is the same as the content of each resin in a top coat layer), and thus the explanations are omitted herein. Measurement—analysis of the presence of each resin is the same as the measurement—analysis of the presence of resin in top coat layer, and thus the explanations are omitted herein.

Furthermore, specific explanations of another component(s) which may also be contained, if necessary, in the composition for forming a top coat of a leather material according to the present invention are the same as those described above, and thus the explanations are omitted herein. In consideration of the coating property, it is preferable that the composition for forming a top coat of a leather material according to the present invention additionally contains a solvent like water. The amount of the solvent is not particularly limited, but it is such an amount as to give a total solid content concentration preferably of approximately 75 to 99% by weight, and more preferably of approximately 80 to 95% by weight.

In the case where the composition for forming a top coat of a leather material according to the present invention contains a crosslinking agent (curing agent), the composition can be any one of one-component type including all the constitutional components therein and two-component type including a main preparation which consists of components other than a crosslinking agent (curing agent), and a crosslinking agent (curing agent).

A method for coating the composition for forming a top coat of a leather material (top coating agent) is not particularly limited, and examples of the method include brush coating, spray painting, curtain painting, roll painting, and the like. After the coating, the solvent is removed by drying a coating film, if necessary. Consequently, a top coat is formed. It is preferable to coat the composition for forming a top coat of a leather material (top coating agent) separately a plurality of times. By this, the surface evenness of a top coat layer can be further enhanced (i.e., surface roughness can be reduced), and more even thickness of a top coat can be obtained. As a result, gloss of the leather material can be further enhanced. Furthermore, it is also possible to prevent unevenness caused by liquid flow, and reduce drying time. The number of the painting is not particularly limited, and can be suitably selected in consideration of total thickness of a top coat or the like. In consideration of thickness of a top coat, operability, or the like, number of the painting is generally 2 to 5 times, and preferably 2 to 3 times.

Coating amount of the composition for forming a top coat of a leather material (top coating agent) is not particularly limited, but it is preferably selected so as to give the aforementioned thickness.

In the case where the leather material has 2 or more layers of top coat, the above operation is carried out 2 or more times. Consequently, a top coat is formed. The top coat (in particular, outermost top coat) maybe subjected to treatment for reducing surface roughness. By the operation, the surface roughness (Ra) of the outermost top coat can be easily adjusted to a desired value (preferably, 3 or less). Herein, the method for reducing surface roughness is not particularly limited, but a mirror surface roller, a mat roller, or the like can be used. Conditions for reducing surface roughness are not particularly limited, and it is only required that they set at the conditions for having desired surface roughness (Ra). For example, a roller may be applied on a top coat with heat of 75 to 120° C. at pressure of 20 to 70 Bar and rate of 1.0 to 4.0 m/minute.

As such, a top coat having high gloss can be formed. Herein, the gloss of a top coat (particularly, outermost top coat) is not particularly limited, but it is A or higher, and preferably O in “1. Evaluation of gloss” of [Performance evaluation] in the following Examples.

### (Leather Substrate)

The leather substrate is not particularly limited, and it can be any one of synthetic leather such as PVC leather or urethane synthetic leather, natural leather substitute such as split leather, and natural grain leather (so-called genuine leather). Among them, from the viewpoint of product value (luxury feeling) or the like, genuine leather is preferable. Thus, in the preferred embodiment of the present invention, the leather substrate is genuine leather. Herein, the genuine leather is not particularly limited in terms of the type or part of an animal to be used. Examples thereof include natural leather from mammals such as cow, sheep, goat, pig, horse, kangaroo, elephant, rabbit, deer, cat, dog, leopard, raccoon, fox, weasel, sable, mink, camel, reindeer, seal, or sea lion; birds such as ostrich; or reptiles such as sea turtle, monitor lizard, python, or crocodile. Furthermore, the part of the animal is not particularly limited, either, and leather from a part which can be used as genuine leather, for example, leather from back, hip, abdomen, or the like can be suitably used.

Furthermore, a method for producing a leather substrate is not particularly limited, and a well-known method can be applied. Specifically, by subjecting raw skin (raw leather) to, in order, a preparation step consisting of soaking in water, washing with water, fleshing, liming, splitting, degreasing, and washing with water; a tanning step consisting of deliming, washing with water, immersion in acid, and tanning (tanning with chrome or chrome-free tanning agent, and retanning with synthetic tanning agent); and a drying step, a crust leather is preferably obtained. Namely, in the preferred embodiment of the present invention, the leather substrate is a crust leather.

### (Base Coat)

The base coat may be directly formed on a leather substrate, or it may be formed on a leather substrate via another layer. Preferably, the base coat is directly formed on a leather substrate. The base coat functions to flatten irregularities that are present on a surface of a leather substrate. By forming a base coat, a layer can be stably formed on top of a base coat . The base coat can be either 1 layer or have stack form with 2 or more layers.

Herein, the base coat is not particularly limited, and the same material, thickness, or the like as those commonly used in the field of a leather material can be applied. For example, the base coat contains (i) a resin such as an aliphatic polyurethane resin, a fatty acid modified polyurethane resin, an aromatic polyurethane resin, and an aliphatic polyurethane acrylic resin, and (ii) other components such as a pigment, an aid (e.g., surfactant, thickening agent, adjusting agent, matt agent, and the like), a feeling agent, a leveling agent, and the like. Composition of (i) the resin and (ii) other components for constituting the base coat is not particularly limited, and the same composition as conventional composition can be similarly applied. Furthermore, thickness of the base coat is not particularly limited, ant it can be the same as the thickness of a base coat of a common leather material. Specifically, thickness of the base coat (total thickness in dry state) is preferably 15 to 45 μm, and more preferably 20 to 35 μm. With this thickness, irregularities on a surface of the leather substrate can be sufficiently flattened.

A method for forming a base coat is not particularly limited, either, and a method of preparing a composition for forming a leather material base coat (base coating agent), which contains the above components (i) and (ii) and a solvent, and coating the base coating agent on a leather substrate can be employed. Herein, specific explanations of the solvent are the same as those described above for the composition for forming a top coat, and thus explanations are omitted herein. An amount of the solvent is not particularly limited, but it is such an amount as to give total solid content concentration preferably of approximately 75 to 99% by weight, and more preferably of approximately 80 to 95% by weight.

A method for coating the composition for forming a leather material base coat (base coating agent) is not particularly limited, and examples of the method include brush coating, spray painting, curtain painting, roll painting, and the like. After the coating, the solvent is removed by drying a coating film, if necessary. By this, a base coat is formed.

Coating amount of the composition for forming a leather material base coat (base coating agent) is not particularly limited, but it is preferably selected so as to give the aforementioned thickness.

After forming the base coat, it can be subjected to embossing. By embossing, various shapes (grain leather pattern) can be provided to the leather material as a final product by a processing for creating irregularities on a surface of a leather substrate by high pressure pressing. In the case of carrying out embossing, it is also possible to perform, after the pressing, a milling step and a staking step. According to those steps, fibers of a leather substrate are disentangled to adjust texture.

### (Color Coat)

The color coat may be directly formed on a leather substrate, or it may be formed on a leather substrate via another layer (e.g., base coat). Preferably, the color coat is formed on a base coat. The color coat contains a pigment or a dye for coloration of a leather substrate. The color coat can be either 1 layer or have stack form with 2 or more layers.

Herein, the color coat is not particularly limited, and the same material, thickness, or the like as those commonly used in the field of a leather material can be applied. For example, the color coat contains (a) a resin such as an aliphatic polyurethane resin, a fatty acid modified polyurethane resin, an aromatic polyurethane resin, and an aliphatic polyurethane acrylic resin, and (b) other components such as a pigment, an aid (e.g., surfactant, leveling agent, thickening agent, adjusting agent, and the like), a crosslinking agent, a feeling agent, and the like. Composition of (a) the resin and (b) other components for constituting the color coat is not particularly limited, and the same composition as conventional composition can be similarly applied. Furthermore, thickness of the color coat is not particularly limited, ant it can be the same as the thickness of a color coat of a common leather material. Specifically, thickness of the color coat (total thickness in dry state) is preferably 5 to 25 μm, and more preferably 10 to 20 rim. With this thickness, a desired colored state can be sufficiently exhibited.

A method for forming a color coat is not particularly limited, either, and a method of preparing a composition for forming a leather material color coat (color coating agent), which contains the above components (a) and (b) and a solvent, and coating the color coating agent on a base coat can be used. Herein, specific explanations of the solvent are the same as those described above for the composition for forming a top coat, and thus explanations are omitted herein. An amount of the solvent is not particularly limited, but it is such an amount as to give total solid content concentration preferably of approximately 75 to 99% by weight, and more preferably of approximately 80 to 95% by weight.

A method for coating the composition for forming a leather material color coat (color coating agent) is not particularly limited, and examples of the method include brush coating, spray painting, curtain painting, roll painting, and the like. After the coating, the solvent is removed by drying a coating film, if necessary. By this, a color coat is formed.

Coating amount of the composition for forming a leather material color coat (color coating agent) is not particularly limited, but it is preferably selected so as to give the aforementioned thickness.

### (Use)

The leather material of the present invention has improved gloss. Because the leather material of the present invention has a top coat formed by coating of a coating agent which contains specific three types of resin on a leather substrate, it has excellent mass productivity. Thus, the leather material of the present invention can be used for various products including an interior material for an automobile, an interior product such as couch, shoes, and a bag. From the viewpoint that, in addition to the high gloss, it has excellent flex resistance and excellent abrasion resistance and can be applied to complex shape, the leather material of the present invention can be suitably used for a steering wheel, a sheet, a door, a dashboard, an assist grip, and grips for an automobile, and the like, for example.

### EXAMPLES

Hereinafter, the effect(s) of the present invention will be explained by using the following Examples and Comparative Examples. However, the technical scope of the present invention is not limited to the following Examples. Furthermore, unless specifically described otherwise, the operations of the following Examples were carried out at room temperature (25° C.). Furthermore, unless specifically described otherwise, the terms “%” and “parts” mean “% by weight” and “parts by weight”, respectively.

### Examples 1

A two-component type polyurethane resin, a pigment, an aid, a feeling agent, a leveling agent, and water were admixed with one another such that the total concentration of the resin, pigment, aid, feeling agent, and leveling agent is 35% by weight in the composition, and thus a composition for forming a base coat was prepared. The resin, pigment, and aid were admixed with one another at 60:15:25 (weight ratio of resin:pigment:aid). Further, as an aid, a surfactant, a thickening agent, an adjusting agent, a matt agent, and an anti-adhesive agent were used.

A two-component type polyurethane resin, a pigment, an aid, a crosslinking agent, and water were admixed with one another such that the total concentration of the resin, pigment, aid, and crosslinking agent is 30% by weight in the composition, and thus a composition for forming a color coat was prepared. The resin, pigment, aid, and crosslinking agent were admixed with one another at 60:20:10:10 (weight ratio of resin:pigment:aid:crosslinking agent). Further, as an aid, a surfactant (leveling agent or the like), a thickening agent, an adjusting agent, a matt agent, and an anti-adhesive agent were used.

A polycarbonate polyurethane resin (pH: 7 to 9, solid content: 40% by weight, viscosity (25° C.): 50 to 75cps (mPa·s), density: 0.9 to 1.1 mg/cm³), a polyester polyurethane resin (pH: 7 to 10, solid content: 33% by weight, viscosity (25° C.): 250 to 300 cps (mPa·s), density: 0.9 to 1.1 mg/cm³), a polyether polyurethane resin (pH: 8 to 11, solid content: 38% by weight, viscosity (25° C.): 40 to 75cps (mPa·s), density: 0.9 to 1.1 mg/cm³), a pigment, an isocyanate based crosslinking agent, and water were admixed with one another at blending ratio (weight ratio) shown in the following Table 1 to prepare a composition 1 for forming a top coat. In the following Table 1, the polycarbonate polyurethane resin is described as “PC-PU resin”, the polyester polyurethane resin is described as “PES-PU resin”, and the polyether polyurethane resin is described as “PE-PU resin”, respectively. In the row of blending in the following Table 1, the blending ratio of each component (% by weight) is expressed in the upper part when the total amount of the composition for forming a top coat is regarded as 100% by weight. Also, the blending ratio of each resin (% by weight) is expressed in the lower part when the total amount of the polycarbonate polyurethane resin, the polyester polyurethane resin, and the polyether polyurethane resin contained in the composition for forming a top coat is regarded as 100% by weight.

Cow leather of which surface has not been subjected to buff polishing (chrome-free substrate, thickness: 1.2 mm) was used as a leather substrate. On this substrate, the composition for forming a base coat as prepared above was coated by using a roll coater, to form a base coat (thickness in dry state: 25 ml) on the leather substrate, to obtain a base material 1.

Next, the composition for forming a color coat as prepared above was coated on the base coat of the base material 1 by spray painting, to form a color coat (thickness in dry state: 15 μm) on the base coat of the base material 1, to obtain a base material 1′.

Furthermore, the composition 1 for forming a top coat as prepared above was coated on the color coat of the base material 1′ by spray painting, to form a top coat 1 (thickness in dry state: 10 μm) on the color coat of the base material 1′, to obtain a base material 1″. Next, the composition 1 for forming a top coat as prepared above was coated on the top coat 1 of the base material 1″ by spray painting, to form a top coat 2 (thickness in dry state: 10 μm) on the top coat 1 of the base material 1″. Consequently, a leather material 1 having the top coat layers (thickness in dry state: 20 μm) formed on the color coat was obtained.

The surface of the resultant leather material 1 was brought into contact with a mirror surface roller with heat of 100±10° C. at pressure of 50±10 Bar and rate of 2.5±0.5 m/minute, to obtain a leather material 1′. The resultant leather material 1′ was measured for surface roughness (Ra) according to the following method, to be found to be not more than 3. The surface smoothness of thus-obtained leather material 1′ was enhanced, to improve its texture.

### Examples 2-5, Comparative Examples 1-5

A polycarbonate polyurethane resin (pH: 7 to 9, solid content: 40% by weight, viscosity (25° C.): 50 to 75cps (mPa·s), density: 0.9 to 1.1 mg/cm³), a polyester polyurethane resin (pH: 7 to 10, solid content: 33% by weight, viscosity (25° C.):250 to 300 cps (mPa·s), density: 0.9 to 1.1 mg/cm³), a polyether polyurethane resin (pH: 8 to 11, solid content: 38% by weight, viscosity (25° C.):40 to 75cps (mPa·s), density: 0.9 to 1.1 mg/cm³), a pigment, an isocyanate based crosslinking agent, and water were admixed with one another at blending ratio (weight ratio) shown in the following Table 1, to prepare compositions 2-5 for forming a top coat and comparative compositions 1-5 for forming a top coat.

Leather materials 2-5 and comparative leather materials 1-5 were obtained in the same manner as in Example 1 except that the compositions 2-5 for forming a top coat and comparative compositions 1-5 for forming a top coat were respectively used instead of the composition 1 for forming a top coat.

### [Performance Evaluation]

The leather materials 1 to 5 obtained by Examples 1 to 5 and the comparative leather materials 1 to 5 obtained by Comparative Examples 1 to 5 were evaluated for gloss, tensile strength (Tensile), elongation, flex resistance (Newark Flex), light resistance, and abrasion resistance (Abrasion) according to the following methods. The results are shown in the following Table 1.

### 1. Evaluation of Gloss

Gloss was evaluated by using a gloss meter (Micro-gloss 60 manufactured by BYK). The results are shown in the following Table 1. In the Table 1, ◯, Δ, and × are based on the following criteria. With regard to the following criteria, it is practically acceptable if the evaluation is Δ or ◯.

### (Evaluation Criteria for Gloss)

◯: Gloss of 20% or more and 35% or less
Δ: Gloss of 8% or more but less than to 20%
×: Gloss of less than 8%

### 2. Measurement of Tensile Strength (Tensile)

According to ASTM D2209, tensile strength (Tensile) was measured. Specifically, compositions 1 to 5 for forming a top coat and comparative compositions 1 to 5 for forming a top coat were respectively prepared in the same manner as Examples 1 to 5 and Comparative Examples 1 to 5. A film was prepared by using the obtained coating materials respectively. The film was cut to have a shape of FIG. 2 shown in ASTM D2209, to obtain a test sample. After measuring a thickness of each test sample, the test sample was stretched with an Instron tester according to ASTM D2209 until tearing was completed, and a pressure (psi) to which the load at that time was applied was measured. The measured values are shown in the following Table 1.

### 3. Measurement of Elongation

A test sample (length: X0 (mm)) was prepared in the same manner as the above Section 2. The test sample was stretched with an Instron tester according to ASTM D2209 until it broke, and a film length (X1 (mm)) at that time was measured. An elongation [=(X1/X0)×100 (%)] was measured by dividing the length (X1 (mm)) by the length of test sample before the test (X0 (mm)) and multiplying the resultant value by 100. The results are shown in the following Table 1.

### 4. Evaluation of Flex Resistance (Newark Flex)

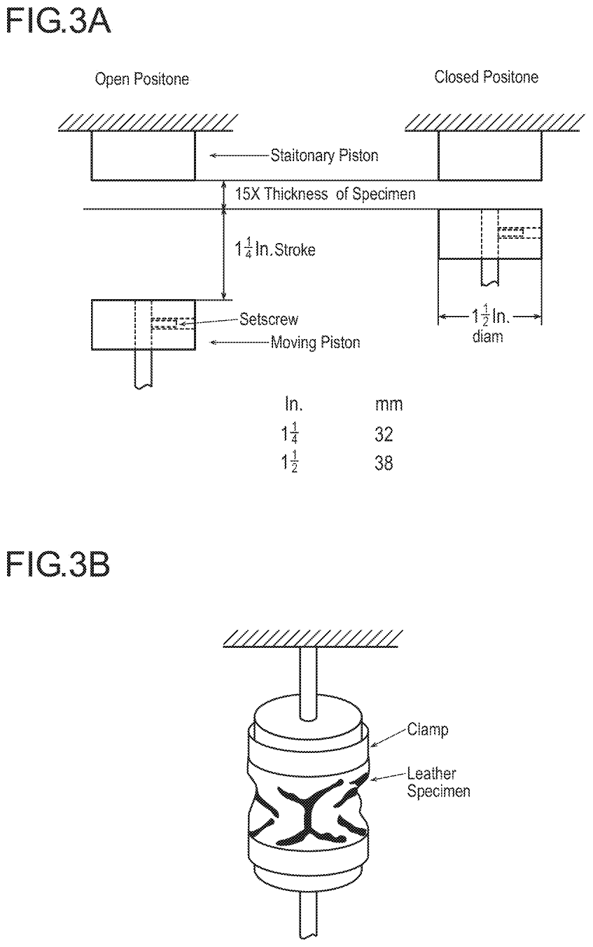

Flex resistance (Newark Flex) was evaluated according to ASTM D2097. Specifically, each leather material was cut to a size of 76 mm×114 mm (width×length), to obtain a test piece. By using a Newark Flex Machine which has been experimentally produced as shown in FIG. 3A, the test piece was wound in natural state according to the standard of ASTM D2097 (FIG. 3B). After bending back and forth 100, 000 times with a stroke of 32 mm, presence or absence of cracks in the surface coating layer (top coat 2) of the test piece was observed. The results are shown in the following Table 1. In the following Table 1, ◯, Δ, and × are based on the following criteria. With regard to the following criteria, it is practically acceptable if the evaluation is Δ or ◯.

### (Evaluation Criteria for Flex Resistance (Newark Flex))

◯: Cracks cannot be confirmed on the surface coating layer.
Δ: Cracks can be confirmed on the surface coating layer, but the cracks do not reach the leather substrate.
×:Cracks can be confirmed on the surface coating layer, and the cracks reach the leather substrate.

### 5. Evaluation of Light Resistance

By using a xenon lamp tester, light resistance was evaluated at the following water-cooling conditions.

### (Conditions for Evaluation)

Irradiance: 340 nm
Temperature of black panel: 89±3° C. for light cycle
   38±3° C. for dark cycle
Relative humidity: 50% RH for light cycle
   100% RH for dark cycle

Cycle time: 3.8 hours for light cycle
1.0 hour for dark cycle
Filter: quartz for the inner side
   sodium borosilicate for the outer side
Lamp: 6.5 kW.

The results are shown in the following Table 1. In the following Table 1, ◯ and × are based on the following criteria.

### (Evaluation Criteria for Light Resistance)

◯: Level of discoloration of a test piece after irradiation is level 4 or higher of grey scale.
×: Level of discoloration of a test piece after irradiation is lower than level 4 of grey scale.

### 6. Evaluation of Abrasion Resistance (Abrasion)

By using a taper abrasion tester, abrasion resistance (Abrasion) was evaluated under conditions including abrasion wheel H-18, load of 4.9 N, and rotation speed of 60 rpm. The results are shown in the following Table 1. In the following Table 1, ◯, Δ, and × are based on the following criteria. With regard to the following criteria, it is practically acceptable if the evaluation is Δ or ◯.

### (Evaluation Criteria for Abrasion Resistance (Abrasion))

◯: No appearance abnormality such as abrasion appears on a surface coating film even if it continues to rotate more than 2000 times.
Δ: Appearance abnormality appears on a surface coating film before continuing the rotation of 2000 times, but a leather substrate cannot be seen even if the rotation is continued for 2000 times (i.e., no appearance abnormality does not reach the leather substrate).
×: Appearance abnormality such as abrasion appears on a surface coating film and a leather substrate can be seen if it continues to rotate more than 2000 times.

### 7. Measurement of Surface Roughness (Ra)

Surface roughness of the outermost top coat of a leather material was measured by using an optical interference type surface roughness detector (SV-C3200 manufactured by Mitutoyo Corporation) according to JIS B0601: 1994.

TABLE 1

| | | Ex- | Ex- | Ex- | Ex- | Ex- | Com- | Com- | Com- | Com- | Com- |
|---|---|---|---|---|---|---|---|---|---|---|---|
| | | ample | ample | ample | ample | ample | parative | parative | parative | parative | parative |
| | | 1 | 2 | 3 | 4 | 5 | Example 1 | Example 2 | Example 3 | Example 4 | Example 5 |
| Composition | PC-PU resin | 18 | 15 | 15 | 25 | 25 | 0 | 20 | 20 | 60 | 60 |
| of top coat 2 | | 22.5 | 18.75 | 18.75 | 31.25 | 31.25 | 0 | 25 | 25 | 75 | 75 |
| (% by | PES-PU resin | 31 | 35 | 30 | 30 | 25 | 60 | 60 | 0 | 20 | 0 |
| weight) | | 38.75 | 43.75 | 37.5 | 37.5 | 31.5 | 75 | 75 | 0 | 25 | 0 |
| | PE-PU resin | 31 | 30 | 35 | 25 | 30 | 20 | 0 | 60 | 0 | 20 |
| | | 38.75 | 37.5 | 43.75 | 31.25 | 37.5 | 25 | 0 | 75 | 0 | 25 |
| | Water | 10.5 | 10.5 | 10.5 | 10.5 | 10.5 | 10.5 | 10.5 | 10.5 | 10.5 | 10.5 |
| | Pigment | 5 | 5 | 5 | 5 | 5 | 5 | 5 | 5 | 5 | 5 |
| | Crosslinking agent | 4.5 | 4.5 | 4.5 | 4.5 | 4.5 | 4.5 | 4.5 | 4.5 | 4.5 | 4.5 |
| Performance | Gloss | ∘ | ∘ | ∘ | ∘ | ∘ | x | ∘ | ∘ | ∘ | ∘ |
| evaluation | Tensile strength | 52.2 | 92.4 | 90.0 | 84.0 | 72.9 | 47.3 | 56.3 | 95.0 | 82.9 | 125.2 |
| | (Tensile) (psi) | | | | | | | | | | |
| | Elongation (%) | 221 | 247 | 235 | 237 | 230 | 183 | 146 | 469 | 139 | 213 |
| | Flex resistance | ∘ | ∘ | ∘ | ∘ | ∘ | x | Δ | x | Δ | x |
| | (Newark Flex) | | | | | | | | | | |
| | Light resistance | ∘ | ∘ | ∘ | ∘ | ∘ | ∘ | ∘ | ∘ | ∘ | ∘ |
| | Abrasion resistance | ∘ | ∘ | ∘ | ∘ | ∘ | Δ | x | ∘ | x | x |
| | (Abrasion) | | | | | | | | | | |

From the results in the Table 1, it is noted that the leather materials of Examples 1 to 5 can show high gloss while maintaining flex resistance and abrasion resistance. On the contrary, the comparative leather materials 1 to 5, in which any one of the polycarbonate polyurethane resin, the polyester polyurethane resin, and the polyether polyurethane resin is not contained, have inferior gloss, flex resistance, or abrasion resistance.

### REFERENCE SIGNS LIST

1 Leather material
2 Leather substrate
3 Base coat
4 Color coat
5 Top coat
5a Top coat 1
5b Top coat 2

What is claimed is:

1. A leather material comprising a top coat having at least one layer on a leather substrate, wherein at least one of the layer contains a polycarbonate polyurethane resin, a polyester polyurethane resin, and a polyether polyurethane resin.

2. The leather material according to claim 1, wherein the polycarbonate polyurethane resin is contained in the layer at a ratio of 5 to 40% by weight relative to a total weight of the polycarbonate polyurethane resin, the polyester polyurethane resin, and the polyether polyurethane resin,
the polyester polyurethane resin is contained in the layer at a ratio of 15% by weight or more but less than 50% by weight relative to the total weight of the polycarbonate polyurethane resin, the polyester polyurethane resin, and the polyether polyurethane resin, and
the polyether polyurethane resin is contained in the layer at a ratio of 15% by weight or more but less than 50% by weight relative to the total weight of the polycarbonate polyurethane resin, the polyester polyurethane resin, and the polyether polyurethane resin.

3. The leather material according to claim 1, wherein the polycarbonate polyurethane resin is contained in the layer at a ratio of 10 to 25% by weight relative to the total weight of the polycarbonate polyurethane resin, the polyester polyurethane resin, and the polyether polyurethane resin,
the polyester polyurethane resin is contained in the layer at a ratio of 30 to 45% by weight relative to the total weight of the polycarbonate polyurethane resin, the polyester polyurethane resin, and the polyether polyurethane resin, and
the polyether polyurethane resin is contained in the layer at a ratio of 30 to 45% by weight relative to the total weight of the polycarbonate polyurethane resin, the polyester polyurethane resin, and the polyether polyurethane resin.

4. The leather material according to claim 1, wherein thickness (total thickness in dry state) of the top coat is 10 to 40 μm.

5. The leather material according to claim 1, wherein surface roughness (Ra) of the outermost top coat is 3 or less.

6. The leather material according to claim 1, further comprising a base coat and a color coat between the leather substrate and the top coat.

7. The leather material according to claim 1, wherein the leather substrate is genuine leather.

8. The leather material according to claim 1, wherein the top coat has 1 to 3 layers, and at least an outermost layer of the topcoat contains the polycarbonate polyurethane resin, the polyester polyurethane resin, and the polyether polyurethane resin.

9. A composition for forming a top coat of leather material, comprising a polycarbonate polyurethane resin, a polyester polyurethane resin, and a polyether polyurethane resin.

10. The composition according to claim 9, wherein the polycarbonate polyurethane resin is contained at a ratio of 5 to 40% by weight relative to a total weight of the polycarbonate polyurethane resin, the polyester polyurethane resin, and the polyether polyurethane resin,
the polyester polyurethane resin is contained at a ratio of 15% by weight or more but less than 50% by weight relative to the total weight of the polycarbonate polyurethane resin, the polyester polyurethane resin, and the polyether polyurethane resin, and
the polyether polyurethane resin is contained at a ratio of 15% by weight or more but less than 50% by weight relative to the total weight of the polycarbonate polyurethane resin, the polyester polyurethane resin, and the polyether polyurethane resin.

11. The composition according to claim 9, wherein the polycarbonate polyurethane resin is contained at a ratio of 10 to 25% by weight relative to the total weight of the polycarbonate polyurethane resin, the polyester polyurethane resin, and the polyether polyurethane resin,
the polyester polyurethane resin is contained at a ratio of 30 to 45% by weight relative to the total weight of the polycarbonate polyurethane resin, the polyester polyurethane resin, and the polyether polyurethane resin, and
the polyether polyurethane resin is contained at a ratio of 30 to 45% by weight relative to the total weight of the polycarbonate polyurethane resin, the polyester polyurethane resin, and the polyether polyurethane resin.

12. A method for forming a leather material comprising forming a top coat on a leather substrate by using the composition set forth in claim 9.
